(19) United States
(12) Patent Application Publication
(10) Pub. No.: US 2026/0104739 A1
(43) Pub. Date: Apr. 16, 2026

(54) EXTENDABLE DISPLAY AND WEARABLE DEVICE WITH EXTENDABLE DISPLAY

(71) Applicants: INVENTEC APPLIANCES CORPORATION, New Taipei City (TW); INVENTEC APPLIANCES (PUDONG) CORPORATION, Shanghai (CN)

(72) Inventors: SZU-TSUNG CHANG, New Taipei City (TW); HSIANG TI HSU, New Taipei City (TW)

(21) Appl. No.: 19/315,892

(22) Filed: Sep. 2, 2025

Related U.S. Application Data
(60) Provisional application No. 63/707,235, filed on Oct. 15, 2024.

(51) Int. Cl. G06F 1/16

(52) U.S. Cl. CPC G06F 1/1652; G06F 1/163; G06F 1/1656

(57) ABSTRACT

A wearable device with extendable display includes an extendable display comprising a support structure, a flexible panel, a linkage assembly and a motor. The support structure comprises an upper plate, a lower plate and a roller. A first end of the flexible panel is connected to the upper plate and a second end of the flexible panel is connected to the lower plate, and the flexible panel abuts against the roller. The linkage assembly comprises an upper slide block connected to the upper plate and a lower slide block connected to the lower plate. The linkage assembly allows the upper slide block and the lower slide block to relatively move in opposite directions. The motor is connected to the linkage assembly to drive it. By the motor, the linkage assembly, the upper plate, the lower plate and the roller, a display surface of the flexible panel can extends.

The present application is based on, and claims priority from, U.S. provisional application no.: 63/707,235 filed on Oct. 15, 2024, the disclosure of which is hereby incorporated by reference herein in its entirety.

### BACKGROUND OF THE INVENTION

### 1. Field of the Invention

The present invention relates to an extendable display and a wearable device, and more particularly, to an extendable display capable of increasing display area of smart devices such as smart watches and to a wearable device having the extendable display.

### 2. Description of the Prior Art

With the advancement of technology, smart wearable devices such as smart watches and smart wristbands have become popular among consumers due to their convenience, making them one of the most actively developed areas in the industry. Smart watches offer more comprehensive functionality than smart wristbands. In addition to the features of smart wristbands, smart watches may also include phone call answering, email checking, social media access, music playback, and voice assistant functions, combining portability with multi-functionality.

Since smart watches are worn on the user's wrist, the display screen size of smart watches is generally limited to the width of the wrist for convenience. For example, if the display screen of a smart watch is too large, wearing it on the wrist may cause accidental collisions to damage the smart watch and cause in convenience during use. Conversely, if the display screen of a smart watch is too small or maintained at the width of the wrist, the likelihood of collision with other objects decreases, but the smaller display screen may struggle to perform the aforementioned smart functions. For example, functions such as touch control, email checking, or social media information access require a larger display screen for touch interaction or to display sufficient information at once, thereby also causing inconvenience in use.

### SUMMARY OF THE INVENTION

Therefore, the present invention provides an extendable display to solve the problems in the prior art. According to an embodiment of the present invention, the extendable display includes a support structure, a flexible panel, a linkage assembly and a motor. The support structure includes an upper plate, a lower plate and a roller, wherein the upper plate and the lower plate are configured on two opposite sides of the support structure, and the roller is configured on one side of the support structure. The flexible panel has a first end and a second end opposite to the first end, and the first end is connected to the upper plate and the second end is connected to the lower plate. A portion of the flexible panel from the position abutting against the roller to the first end is configured as a display surface. The linkage assembly is configured between the upper plate and the lower plate, and includes an upper sliding block and a lower sliding block. The upper sliding block is connected to the upper plate and the lower sliding block is connected to the lower plate. The linkage assembly is configured to link the upper sliding block and the lower sliding block to enable the upper sliding block and the lower sliding block to move relative to each other in opposite directions. The motor is connected to the linkage assembly and configured to drive the linkage assembly. When the motor drives the linkage assembly to enable the upper sliding block to move the upper plate and the first end of the flexible panel along a first direction, and enable the lower sliding block to move the lower plate and the second end of the flexible panel along a second direction opposite to the first direction, the display surface of the flexible panel extends in the first direction; when the motor drives the linkage assembly to enable the upper sliding block to move the upper plate and the first end of the flexible panel along the second direction, and enable the lower sliding block to move the lower plate and the second end of the flexible panel along the first direction, the display surface of the flexible panel retracts in the second direction.

Wherein, the linkage assembly further includes a first screw rod and a second screw rod respectively threaded through the upper sliding block and the lower sliding block, and the upper sliding block and the lower sliding block respectively have an internal thread corresponding to the external thread of the first screw rod and the second screw rod. The linkage assembly further includes a first gear and a second gear respectively sleeved on the first screw rod and the second screw rod, and the first gear is engaged with the second gear and connected to the motor. When the motor drives the first gear to rotate along a direction, the second gear is rotated in an opposite direction by the first gear, causing the first screw rod and the second screw rod to respectively rotate in opposite directions to enable the upper sliding block and the lower sliding block to move relative to each other in opposite directions

Wherein, the linkage assembly further includes a guide rod configured between the first screw rod and the second screw rod, and the upper sliding block and the lower sliding block respectively abut against the guide rod.

Wherein, the support structure further includes an expandable barrier configured between the roller and the upper plate and connected to the upper plate. The expandable barrier is configured to extend and retract during the upper plate moving along the first direction or the second direction to support the flexible panel.

Wherein, the extendable display further includes a display magnetic attachment structure configured in the support structure. The display magnetic attachment structure is configured to attract to a wristband magnetic attachment structure of a wristband to assemble the extendable display with the wristband.

The present invention also provides a wearable device with extendable display to solve the problems in the prior art. According to an embodiment of the present invention, the wearable device with extendable display includes an extendable display and a wristband selectively assembled with each other. The extendable display includes a support structure, a flexible panel, a linkage assembly and a motor. The support structure includes an upper plate, a lower plate and a roller, wherein the upper plate and the lower plate are configured on two opposite sides of the support structure, and the roller is configured on one side of the support structure. The flexible panel has a first end and a second end opposite to the first end, and the first end is connected to the upper plate and the second end is connected to the lower plate. A portion of the flexible panel from the position abutting against the roller to the first end is configured as a display surface. The linkage assembly is configured between the upper plate and the lower plate, and includes an upper sliding block and a lower sliding block. The upper sliding block is connected to the upper plate and the lower sliding block is connected to the lower plate. The linkage assembly is configured to link the upper sliding block and the lower sliding block to enable the upper sliding block and the lower sliding block to move relative to each other in opposite directions. The motor is connected to the linkage assembly and configured to drive the linkage assembly. When the motor drives the linkage assembly to enable the upper sliding block to move the upper plate and the first end of the flexible panel along a first direction, and enable the lower sliding block to move the lower plate and the second end of the flexible panel along a second direction opposite to the first direction, the display surface of the flexible panel extends in the first direction; when the motor drives the linkage assembly to enable the upper sliding block to move the upper plate and the first end of the flexible panel along the second direction, and enable the lower sliding block to move the lower plate and the second end of the flexible panel along the first direction, the display surface of the flexible panel retracts in the second direction.

Wherein, the linkage assembly further includes a first screw rod and a second screw rod respectively threaded through the upper sliding block and the lower sliding block, and the upper sliding block and the lower sliding block respectively have an internal thread corresponding to the external thread of the first screw rod and the second screw rod. The linkage assembly further includes a first gear and a second gear respectively sleeved on the first screw rod and the second screw rod, and the first gear is engaged with the second gear and connected to the motor. When the motor drives the first gear to rotate along a direction, the second gear is rotated in an opposite direction by the first gear, causing the first screw rod and the second screw rod to respectively rotate in opposite directions to enable the upper sliding block and the lower sliding block to move relative to each other in opposite directions

Wherein, the linkage assembly further includes a guide rod configured between the first screw rod and the second screw rod, and the upper sliding block and the lower sliding block respectively abut against the guide rod.

Wherein, the support structure further includes an expandable barrier configured between the roller and the upper plate and connected to the upper plate. The expandable barrier is configured to extend and retract during the upper plate moving along the first direction or the second direction to support the flexible panel.

Wherein, the extendable display further includes a display magnetic attachment structure configured in the support structure, and the wristband further includes a wristband magnetic attachment structure. The extendable display is assembled with the wristband by the display magnetic attachment structure and the wristband magnetic attachment structure attracting to each other.

In summary, the extendable display of this invention uses the linkage assembly to move the upper plate and lower plate relative to each other, thereby extending or retracting the display surface of the flexible panel. It enables the user to use the extended larger screen during operation and the retracted smaller screen when not in use. As a result, the wearable device with extendable display offers greater flexibility and convenience in use.

### BRIEF DESCRIPTION OF THE APPENDED DRAWINGS

FIG. 1A is a schematic diagram illustrating a wearable device and an extendable display thereof according to an embodiment of the present invention.

FIG. 1B is a schematic diagram illustrating the extendable display of FIG. 1A extending outward.

FIG. 2A is an internal schematic diagram illustrating the extendable display according to an embodiment of the present invention.

FIG. 2B is a cross-sectional schematic diagram illustrating the extendable display of FIG. 2A from another perspective.

FIG. 3A is an internal schematic diagram illustrating the flexible panel of the extendable display of FIG. 2A extending outward.

FIG. 3B is a cross-sectional schematic diagram illustrating the extendable display of FIG. 3A from another perspective.

FIG. 4A is an internal schematic diagram illustrating the extendable display according to an embodiment of the present invention.

FIG. 4B is an internal schematic diagram illustrating the extendable display of FIG. 4A extending outward.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments.

In the descriptions of this specification, the terms “an embodiment,” “another embodiment,” or “some embodiments” refer to at least one embodiment of the present invention that includes the specific features, structures, materials, or characteristics described in the embodiment. In this specification, the illustrative expressions of the above terms do not necessarily refer to the same embodiment. Furthermore, the specific features, structures, materials, or characteristics described may be combined in any one or more embodiments in an appropriate manner.

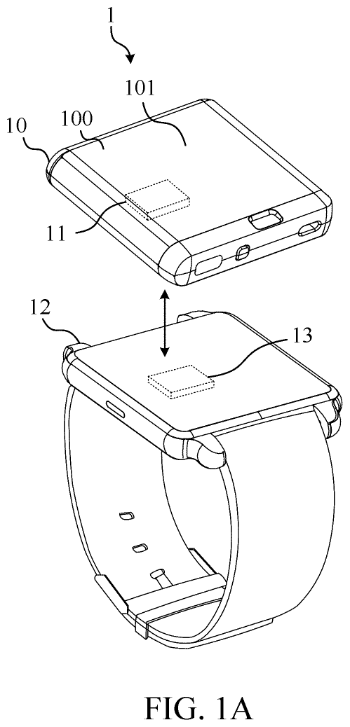

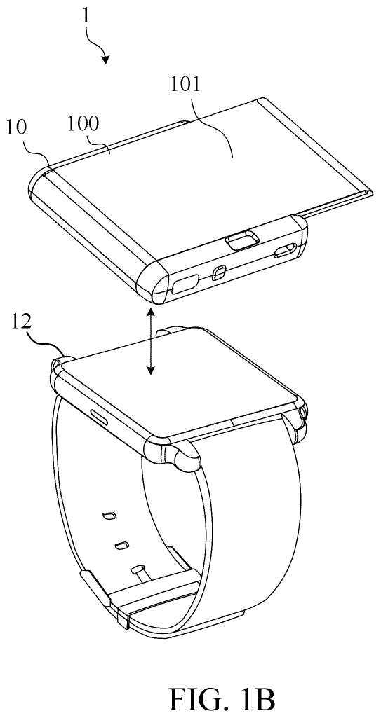

Please refer to FIG. 1A and FIG. 1B. FIG. 1A is a schematic diagram illustrating a wearable device 1 and an extendable display 10 thereof according to an embodiment of the present invention. FIG. 1B is a schematic diagram illustrating the extendable display 10 of FIG. 1A extending outward. As shown in FIG. 1A, in this embodiment, the wearable device 1 includes an extendable display 10 and a wristband 12, which can be separated from each other or assembled with each other. In this embodiment, the extendable display 10 has a display magnetic attachment structure 11 configured therein and the wristband 12 has a wristband magnetic attachment structure 13 configured therein. These two structures can attract each other to enable the extendable display 10 to be assembled with the wristband 12. Through the magnetic attraction mechanism, the extendable display and the wristband can be easily assembled and separated, allowing the extendable display and the wristband to be used together as a smart watch, or allowing the wristband to be separated from the extendable display and used as a smart wristband. In practice, the extendable display 10 and the wristband 12 can also be assembled and disassembled by other methods, such as snap-on connectors or clamps, and are not limited to the aforementioned magnetic attraction method.

In practice, the extendable display 10 can include various components capable of performing smart functions, such as a processor, various sensors, storage devices, and wireless communication components, to execute smart functions such as, but not limited to, phone call answering, email checking, social media access, music playback, and voice assistant functions. Additionally, the wristband 12 can also include physiological sensors and motion sensors therein, enabling the wristband 12 to function independently as a smart wristband.

On the other hand, the wearable device 1 in the previous embodiment includes an extendable display 10 and a wristband 12 that can be separated from and assembled with each other, but in practice, the extendable display and the wristband can also be non-separable, such as the extendable display serving as the watch body and the wristband serving as the watch band connected to the watch body, enabling the wearable device to be used as a smart watch.

As shown in FIG. 1A and FIG. 1B, in this embodiment, the extendable display 10 has a flexible panel 100 with two states of extending and retracting. When the user wears the wearable device 1 for physical activities such as walking, running or daily activities, the flexible panel 100 of the extendable display 10 can remain in the retracted state, as shown in FIG. 1A. Therefore, the size of the display surface 101 of the extendable display 10 is adapted to the width of the user's wrist, without interfering with the user's normal activities. When the user wears the wearable device 1 and uses its various functions, such as viewing emails or social media on the extendable display 10, the flexible panel 100 of the extendable display 10 can remain in the extended state to increase the size of the display surface 101, as shown in FIG. 1B, thereby enhancing the convenience for the user in viewing the display surface 101 or for touch control with the display surface 101.

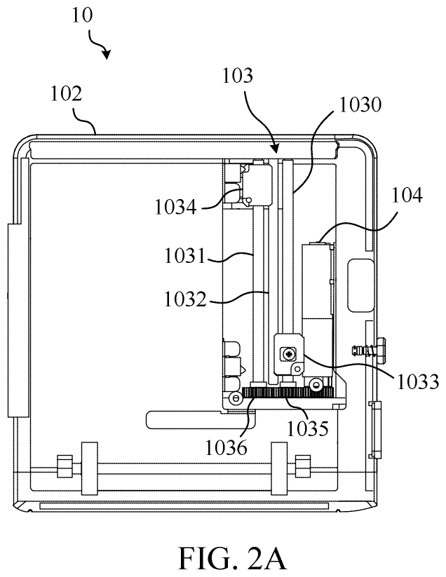

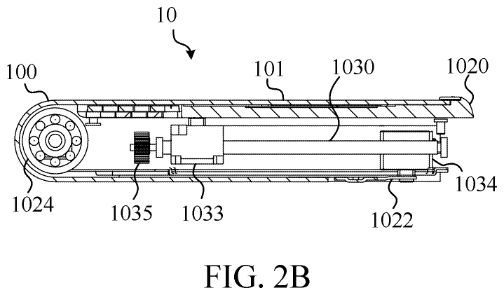

Please refer to FIGS. 2A and 2B together. FIG. 2A is an internal schematic diagram illustrating the extendable display 10 according to an embodiment of the present invention, and FIG. 2B is a cross-sectional schematic diagram illustrating the extendable display 10 of FIG. 2A from another perspective. As shown in FIG. 2A, the extendable display 10 includes a support structure 102, which is the outer casing of the extendable display 10, and a linkage assembly 103 is configured within the support structure 102. The linkage assembly 103 includes a first screw rod 1030, a second screw rod 1031, a guide rod 1032, an upper sliding block 1033, a lower sliding block 1034, a first gear 1035, and a second gear 1036. Wherein, the first screw rod 1030, the second screw rod 1031, and the guide rod 1032 are configured in parallel along the same direction, which is the direction of extension and retraction of the aforementioned flexible panel 100. The upper sliding block 1033 is sleeved on the first screw rod 1030, and the lower sliding block 1034 is sleeved on the second screw rod 1031. Additionally, the first gear 1035 is sleeved on the first screw rod 1030, and the second gear 1036 is sleeved on the second screw rod 1031. It should be noted that, for the sake of simplicity in the drawings, other portions of the internal structure of the support structure 102 are omitted in FIGS. 2A and 2B.

In this embodiment, the first screw rod 1030 and the second screw rod 1031 respectively have an external thread, and the upper sliding block 1033 and the lower sliding block 1034 respectively have an internal thread corresponding to the external thread. It should be noted that in this embodiment, the pitch and direction of the external threads of the first screw rod 1030 and the second screw rod 1031 are the same as those of the internal threads of the upper sliding block 1033 and the lower sliding block 1034.In this embodiment, the first gear 1035 and the second gear 1036 are engaged with each other, and the number of teeth and the diameters of the first gear 1035 and the second gear 1036 are the same. Therefore, the first gear 1035 and the second gear 1036 mesh with each other to rotate the first screw rod 1030 and the second screw rod 1031 at equal speeds but in opposite directions (e.g., clockwise and counterclockwise directions). The guide rod 1032 is configured between first screw rod 1030 and second screw rod 1031, and upper slider 1033 and lower slider 1034 respectively abut against the guide rod 1032. The guide rod 1032 prevents the upper sliding block 1033 and the lower sliding block 1034 from rotating with the first screw rod 1030 and the second screw rod 1031, thereby allowing the upper sliding block 1033 and the lower sliding block 1034 to move along the first screw rod 1030 and the second screw rod 1031 via the external threads and the internal threads when the first screw rod 1030 and the second screw rod 1031 rotate. Additionally, a motor 104 is configured in the extendable display 10, and the first screw rod 1030 can be connected to the motor 104 to be driven by it to rotate in one direction (e.g., clockwise), thereby driving the second screw rod 1031 to rotate in the opposite direction (e.g., counterclockwise), and causing the upper sliding block 1033 and the lower sliding block 1034 to move relative to each other in opposite directions. In this embodiment, the first gear 1035 of the first screw rod 1030 is connected to motor 104, as shown in FIG. 2A, but in practice, it can be the second gear 1036 of the second screw rod 1031 to be connected to the motor 104, and the second gear 1036 can be driven by the motor 104 to drive the first gear 1035 and the first screw rod 1030 to rotate in the opposite direction.

As shown in FIG. 2B, the support structure 102 of the extendable display 10 in the present embodiment further includes an upper plate 1020, a lower plate 1022 and a roller 1024, wherein the upper plate 1020 and the lower plate 1022 are respectively configured on two opposite sides of the support structure 102, and the roller 1024 is configured on one side of the support structure 102. The first end of the flexible panel 100 is connected to the upper plate 1020, and the second end of the flexible panel 100, which is opposite to the first end, is connected to the lower plate 1022. The flexible panel 100 abuts against the rollers 1024. The portion of the flexible panel 100 between the first end and the roller 1024 can serve as the display surface 101 of the extendable display 10, configured to display various functions of the extendable display 10. Therefore, when the upper plate 1020 moves away from the roller 1024 and the lower plate 1022 moves toward the roller 1024, the display surface 101 extends outward to increase the display area. When the upper plate 1020 moves toward the roller 1024 and the lower plate 1022 moves away from the roller 1024, the display surface 101 retracts inward to decrease the display area.

Additionally, the upper sliding block 1033 of the linkage assembly 103 is connected to the upper plate 1020, and the lower sliding block 1034 is connected to the lower plate 1022. As described above, the motor 104 can drive the upper sliding block 1033 and the lower sliding block 1034 of the linkage assembly 103 to move relative to each other in opposite directions. Therefore, when the motor 104 drives the upper sliding block 1033 of the linkage assembly 103 to move in the direction away from the roller 1024 (hereinafter referred to as the first direction), it simultaneously drives the lower sliding block 1034 to move toward the roller 1024 (hereinafter referred to as the second direction). Thereby, the upper plate 1020 connected to the upper sliding block 1033 is driven to move in the first direction, and the lower plate 1022 connected to the lower sliding block 1034 is driven to move in the second direction. The portion of the flexible panel 100 connected to the upper plate 1020 extends outward, causing the display surface 101 of the flexible panel 100 to extend outward and increase the display area.

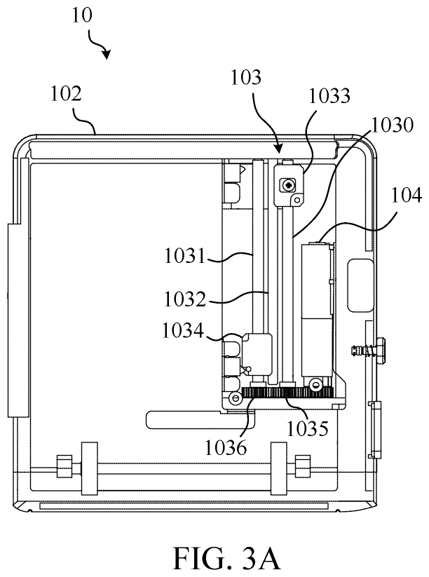

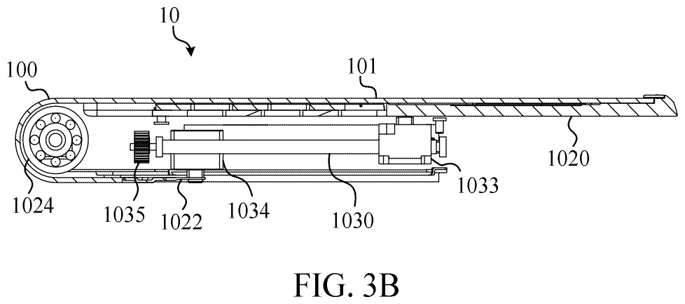

Please refer to FIGS. 2A, 2B, 3A and 3B together. FIG. 3A is an internal schematic diagram illustrating the flexible panel 100 of the extendable display 10 of FIG. 2A extending outward. FIG. 3B is a cross-sectional schematic diagram illustrating the extendable display 10 in FIG. 3A from another perspective. In this embodiment, the motor 104 can drive the upper sliding block 1033 of the linkage assembly 103 of the extendable display 10 to move from the position shown in FIG. 2A in the direction away from the roller 1024 (the first direction) to the position shown in FIG. 3A, while also driving the upper plate 1020 to move toward the direction away from the roller 1024. Additionally, the motor 104 simultaneously drives the lower sliding block 1034 to move from the position shown in FIG. 2A in the direction toward the roller 1024 (the second direction) to the position shown in FIG. 3A, while also driving the lower plate 1022 to move in the direction toward the roller 1024. The first end of the flexible panel 100 is pulled by the upper plate 1020, and the other end (the second end) is pushed by the lower plate 1022. The rollers 1024 are rotated by the movement of the flexible panel 100, so that the portion of the flexible panel 100 hidden within the extendable display 10 extends outward, thereby increasing the area of the display surface 101.

Thus, when the user wishes to use the smart functions of the extendable display 10, the flexible panel 100 of the extendable display 10 can extend outward through the aforementioned linkage assembly 103 to enlarge the display surface 101, as shown in FIG. 1B, so as to allow the user to more easily view the information on the enlarged display surface 101 or interact with it via touch control. After using the extendable display 10, the flexible panel 100 and display surface 101 can retract to avoid interfering with the user's wearing comfort and daily activities.

The retracting process of the flexible panel 100 and the display surface 101 is the reverse of the aforementioned extending process of the flexible panel 100 and the display surface 101. That is to say, the motor 104 drives the upper sliding block 1033 of the linkage assembly 103 of the extendable display 10 from the position shown in FIG. 3A in the direction toward the roller 1024(the second direction) to the position shown in FIG. 2A, while also driving the upper plate 1020 to move in the second direction. Additionally, the motor 104 simultaneously drives the lower slider 1034 from the position shown in FIG. 3A in the direction away from the roller 1024 (the first direction) to the position shown in FIG. 2A, while also driving the lower plate 1022 to move in the first direction. The first end of the flexible panel 100 is pushed by the upper plate 1020 and the second end is pulled by the lower plate 1022. The roller 1024 is rotated by the movement of the flexible panel 100 (the direction of rotation is opposite to that when the flexible panel 100 extends outward), so that the flexible panel 100 retracts inward from the extending state, thereby decreasing the area of the display surface 101.

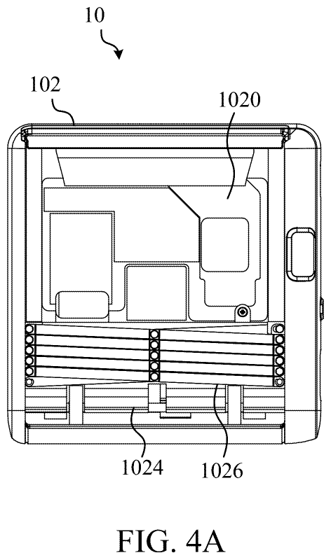

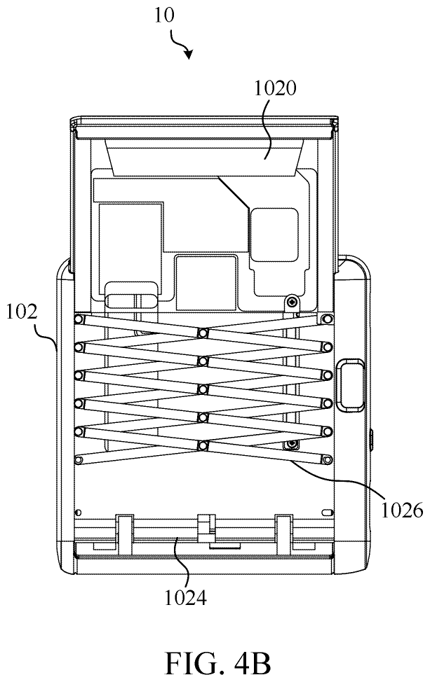

Please refer to FIGS. 4A and 4B. FIG. 4A is an internal schematic diagram illustrating the extendable display 10 according to an embodiment of the present invention, and FIG. 4B is an internal schematic diagram illustrating the extendable display 10 of FIG. 4A extending outward. As shown in FIG. 4A, in this embodiment, the support structure 102 further includes an expandable barrier 1026 disposed between the upper plate 1020 and the rollers 1024 and connected to the upper plate 1020. The expandable barrier 1026 and the upper plate 1020 can jointly support the display surface 101 of the flexible panel 100 as described in the aforementioned embodiment. It should be noted that for the sake of simplicity, the flexible panel 100, the linkage assembly 103, and the motor 104 are omitted in FIGS. 4A and 4B. As shown in FIG. 4A, when the flexible panel 100 of the extendable display 10 does not extend, the expandable barrier 1026 remains in a retracted state and supports the flexible panel 100 together with the upper plate 1020. Additionally, as shown in FIG. 4B, when the flexible panel 100 of the extendable display 10 extends outward, the expandable barrier 1026 is pulled by the upper plate 1020 to extend and supports the flexible panel 100 together with the upper plate 1020. Therefore, regardless of whether the display surface 101 of the flexible panel 100 extends to increase the display area, it is supported by the expandable barrier 1026 and the upper plate 1020, so that the flexible panel 100 maintains stability and ease of operation during use.

In summary, the extendable display of the present invention and the wearable device with the extendable display, such as a smart watch, can increase or decrease the display area of the display surface by the design with the screw rods, the upper sliding block and the lower sliding block to enable the flexible panel to extend outward and retract inward. When the flexible panel is in the retracting state, the extendable display maintains the width of the wearing part (e.g., the user's wrist) without affecting the user's daily activities. When the flexible panel is in the extending state, the increased display area of the extendable display allows the user to view information more easily and perform touch control more easily. Therefore, the extendable display and the wearable device with the extendable display of the present invention offer greater convenience in use.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An extendable display, comprising:
a support structure, comprising an upper plate, a lower plate and a roller, the upper plate and the lower plate being configured on two opposite sides of the support structure, the roller being configured on one side of the support structure;
a flexible panel, comprising a first end and a second end opposite to the first end, the first end being connected to the upper plate and the second end being connected to the lower plate, the flexible panel abutting against the roller, a portion of the flexible panel from the position abutting against the roller to the first end being configured as a display surface;
a linkage assembly, configured between the upper plate and the lower plate, the linkage assembly comprising an upper sliding block connected to the upper plate and a lower sliding block connected to the lower plate, the linkage assembly being configured to link the upper sliding block and the lower sliding block to enable the upper sliding block and the lower sliding block to move relative to each other in opposite directions; and
a motor, connected to the linkage assembly and configured to drive the linkage assembly;
wherein, when the motor drives the linkage assembly to enable the upper sliding block to move the upper plate and the first end of the flexible panel along a first direction, and enable the lower sliding block to move the lower plate and the second end of the flexible panel along a second direction opposite to the first direction, the display surface of the flexible panel extends in the first direction; when the motor drives the linkage assembly to enable the upper sliding block to move the upper plate and the first end of the flexible panel along the second direction, and enable the lower sliding block to move the lower plate and the second end of the flexible panel along the first direction, the display surface of the flexible panel retracts in the second direction.

2. The extendable display of claim 1, wherein the linkage assembly further comprises a first screw rod and a second screw rod respectively threaded through the upper sliding block and the lower sliding block, the upper sliding block and the lower sliding block respectively have an internal thread corresponding to external threads of the first screw rod and the second screw rod, the linkage assembly further comprises a first gear and a second gear respectively sleeved on the first screw rod and the second screw rod, the first gear is engaged with the second gear and connected to the motor, when the motor drives the first gear to rotate along a direction, the second gear is rotated in an opposite direction by the first gear, causing the first screw rod and the second screw rod to respectively rotate in opposite directions to enable the upper sliding block and the lower sliding block to move relative to each other in opposite directions.

3. The extendable display of claim 2, wherein the linkage assembly further comprises a guide rod configured between the first screw rod and the second screw rod, and the upper sliding block and the lower sliding block respectively abut against the guide rod.

4. The extendable display of claim 1, wherein the support structure further comprises an expandable barrier configured between the roller and the upper plate and connected to the upper plate, the expandable barrier is configured to extend and retract during the upper plate moving along the first direction or the second direction to support the flexible panel.

5. The extendable display of claim 1, further comprising a display magnetic attachment structure configured in the support structure, the display magnetic attachment structure being configured to attract to a wristband magnetic attachment structure of a wristband to assemble the extendable display with the wristband.

6. A wearable device with extendable display, comprising:
an extendable display, comprising:
a support structure, comprising an upper plate, a lower plate and a roller, the upper plate and the lower plate being configured on two opposite sides of the support structure, the roller being configured on one side of the support structure;
a flexible panel, comprising a first end and a second end opposite to the first end, the first end being connected to the upper plate and the second end being connected to the lower plate, the flexible panel abutting against the roller, a portion of the flexible panel from the position abutting against the roller to the first end being configured as a display surface;
a linkage assembly, configured between the upper plate and the lower plate, the linkage assembly comprising an upper sliding block connected to the upper plate and a lower sliding block connected to the lower plate, the linkage assembly being configured to link the upper sliding block and the lower sliding block to enable the upper sliding block and the lower sliding block to move relative to each other in opposite directions; and
a motor, connected to the linkage assembly and configured to drive the linkage assembly;
a wristband, selectively assembled with the extendable display to form the wearable device;
wherein, when the motor drives the linkage assembly to enable the upper sliding block to move the upper plate and the first end of the flexible panel along a first direction, and enable the lower sliding block to move the lower plate and the second end of the flexible panel along a second direction opposite to the first direction, the display surface of the flexible panel extends in the first direction; when the motor drives the linkage assembly to enable the upper sliding block to move the upper plate and the first end of the flexible panel along the second direction, and enable the lower sliding block to move the lower plate and the second end of the flexible panel along the first direction, the display surface of the flexible panel retracts in the second direction.

7. The wearable device with extendable display of claim 6, wherein the linkage assembly further comprises a first screw rod and a second screw rod respectively threaded through the upper sliding block and the lower sliding block, the upper sliding block and the lower sliding block respectively have an internal thread corresponding to external threads of the first screw rod and the second screw rod, the linkage assembly further comprises a first gear and a second gear respectively sleeved on the first screw rod and the second screw rod, the first gear is engaged with the second gear and connected to the motor, when the motor drives the first gear to rotate along a direction, the second gear is rotated in an opposite direction by the first gear, causing the first screw rod and the second screw rod to respectively rotate in opposite directions to enable the upper sliding block and the lower sliding block to move relative to each other in opposite directions.

8. The wearable device with extendable display of claim 7, wherein the linkage assembly further comprises a guide rod configured between the first screw rod and the second screw rod, and the upper sliding block and the lower sliding block respectively abut against the guide rod.

9. The wearable device with extendable display of claim 6, wherein the support structure further comprises an expandable barrier configured between the roller and the upper plate and connected to the upper plate, the expandable barrier is configured to extend and retract during the upper plate moving along the first direction or the second direction to support the flexible panel.

10. The wearable device with extendable display of claim 6, wherein the extendable display further comprises a display magnetic attachment structure configured in the support structure, the wristband comprises a wristband magnetic attachment structure, the extendable display is assembled with the wristband by the display magnetic attachment structure and the wristband magnetic attachment structure attracting to each other.
